(19) United States
(12) Patent Application Publication
(10) Pub. No.: US 2009/0193407 A1
(43) Pub. Date: Jul. 30, 2009

(54) Methods and Systems for Automatic Patch Creation for Client Updates

(75) Inventor: Peter Lepeska, Boston, MA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 12/362,245

(22) Filed: Jan. 29, 2009

Related U.S. Application Data
(60) Provisional application No. 61/024,384, filed on Jan. 29, 2008.

(51) Int. Cl. G06F 9/44

(52) U.S. Cl. 717/170; 717/173

(57) ABSTRACT

The present invention relates to systems, apparatus, and methods of implementing software version management for automatically updating a client system. The method includes establishing a server system and one or more client systems within a network and installing binaries on the server system and the one or more client systems. The method further includes maintaining the installed binaries on the server system, and updating the server system with new binaries. Further, the method includes storing, on the server system, the previous binaries, receiving a connection request to connect to the server system from at least one of the one or more client systems, and determining that the client system's binaries are out-of-date. The method then automatically transmits the new binaries to the client system to replace the out-of-date binaries.

### PRIORITY CLAIM

This application claims priority to U.S. Provisional Patent Application Ser. No. 61/024,384, filed Jan. 29, 2008, entitled “METHODS AND SYSTEMS FOR AUTOMATIC PATCH CREATION FOR CLIENT UPDATES,” Attorney Docket No. 026841-000110US, which is hereby incorporated be reference herein in its entirety for any purpose.

### FIELD OF THE INVENTION

The present invention relates, in general, to network acceleration and, more particularly, to patch creation.

### BACKGROUND

Typically, when installing applications on client machines, a Microsoft™ Installation (MSI) file is downloaded and installed on the client machine. When an update and/or patch for the application is made available, the client machine must first download the patch/update. Then, one of two processes occurs. The client will uninstall the old MSI and manually reinstall the updated MSI, or a Microsoft™ Patch (MSP), which will apply the update/patch, is applied to the previous MSI installation.

There are a number of problems with this current implementation. First, every client on a network must download the patch/update which can be bandwidth and recourse intensive. Second, the MSI and MSP must be manually created for each new update/patch, which is time consuming, complicated (a significant amount of documentation needed to guide an administrator), and labor intensive. Third, because of the difficulty in creating MSI and MSP files, such files are error prone. Fourth, clients are oftentimes fearful of downloading a patch/update because of potential compatibility and/or bug issues. Fifth, once a MSI file is created, it is difficult to distribute. Lastly, MSP files limit what can be patched/updated and often will require a full upgrade anyway. Thus, improvements in the art are needed.

### BRIEF SUMMARY

Embodiments of the present invention are directed to a method of implementing software version management for automatically updating a client system. The method includes establishing a server system and one or more client systems within a network and installing binaries on the server system and the one or more client systems. The method further includes maintaining the installed binaries on the server system, and updating the server system with new binaries. Further, the method includes storing, on the server system, the previous binaries, receiving a connection request to connect to the server system from at least one of the one or more client systems, and determining that the client system's binaries are out-of-date. The method then automatically transmits the new binaries to the client system to replace the out-of-date binaries.

According to further embodiments, a system for implementing software version management is described. The system includes one or more client devices, each having a proxy client. The system further includes a proxy server in communication with the one or more client devices via the proxy clients. The proxy server has a storage device, and is configured to install binaries on the storage device, direct the proxy clients to install the binaries on the one or more client devices, and maintain the installed binaries. The proxy server is further configured to update the installed binaries on the storage device with new binaries, store on the storage device the previous binaries and receive a connection request from at least one of the one or more client devices via the proxy clients. Furthermore, the proxy client is configured to determine that the client system's binaries are out-of-date, and automatically transmit the new binaries to the client system to replace the out-of-date binaries.

In an alternative embodiment, a machine-readable medium is described. The machine-readable medium includes instructions for implementing software version management for automatically updating a client system. The machine-readable medium includes instructions for establishing a server system and one or more client systems within a network and installing binaries on the server system and the one or more client systems. The machine-readable medium further includes instructions for maintaining the installed binaries on the server system, and updating the server system with new binaries. Further, the machine-readable medium includes instructions for storing the previous binaries on the server system, receiving a connection request to connect to the server system from at least one of the one or more client systems, and determining that the client system's binaries are out-of-date. The machine-readable medium includes instructions for automatically transmitting the new binaries to the client system to replace the out-of-date binaries.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a flow diagram illustrating a method for automated patch creation, according to embodiments of the present invention.

FIG. 2 is a flow diagram illustrating a method of automated patch creation, according to another embodiment of the present invention.

FIG. 3 is a block diagram illustrating a system for automated patch creation, according to one embodiment of the present invention.

FIG. 4 is a generalized schematic diagram illustrating a computer system, in accordance with various embodiments of the invention.

FIG. 5 is a block diagram illustrating a networked system of computers, which can be used in accordance with various embodiments of the invention.

### DETAILED DESCRIPTION OF THE INVENTION

Aspects of the disclosure relate to automatic patch creation and distribution. In one embodiment, in distributed network environments (e.g., a server and multiple client systems), each client system has client binaries installed from the server. When the server is updated the new binaries are stored on the server and the old binaries are also maintained. Subsequently, when a client system connects to the server, the server checks the version of the client's binaries. If the binaries are out-of-date, then the server creates a patch which only includes the changed portions of the binaries. The patch may then be installed on the client system, thus automatically updating the client system using a minimal amount of network resources. Hence, if the server version changes whenever a client connects to the server, the client's version changes to match the server's version.

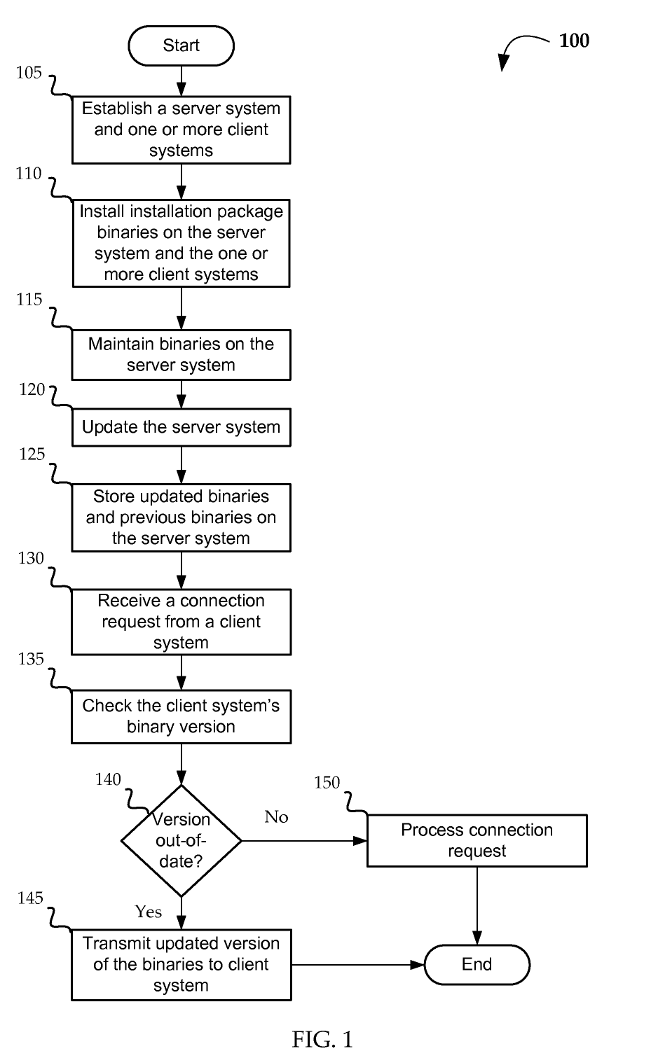

Turning now to FIG. 1, which illustrates a method 100 for automatically patching a client system upon connection to a server system, according to aspects of the present invention. At process block 105, a server system and one or more client systems may be established. In one embodiment, the server system and the client systems may be located in a local area network (LAN), a wide area network (WAN), over the Internet, etc. The server system and the client systems may be connected using a variety of connection types (e.g., a cable connection, a digital subscriber line (DSL), dial-up connection, a satellite connection, a wireless connection, a WiFi connection, a cellular connection, integrated services digital network (ISDN) connection, etc.).

At process block 110, installation package binaries may be installed on the server system. In one embodiment, the installation package is configured to connect the server system with the client systems in order to accelerate the client systems' Internet and/or network connections. In a further embodiment, the server system may be configured to be a proxy server to the client systems. The installation package binaries may further be installed on the client systems by the server system. In one embodiment, the installation binaries may be configured to implement client proxies on the client systems which may then communicate with the proxy server. In a further embodiment, the installation package may be a Microsoft™ Windows installer (MSI); nonetheless, other installation protocols may be used.

At process block 115, all binaries may be maintained on the server. The binaries may be stored locally in the server's storage space or may be stored at a remote location connected with the server. In one embodiment, the server may maintain archives of the past binaries in order to allow for backwards compatibility and/or downgrading of the server and/or the client systems. For example, when the server system is updated (process block 120), in order for the client systems to be able to continue to communicate with the updated server, the client systems should also be updated. However, client systems may have an incompatible version of the binaries, and thus different updated binaries may be needed in order to properly update each of the clients. Accordingly, the server system may store the current version of the binaries and all of the previous versions of the binaries (process block 125). In one embodiment, if the client and server have incompatible versions of the binaries, the client and the server may have a wire-line protocol that can change in response to the incompatibility in order to allow the client and the server to establish a connection despite the incompatibility.

Subsequently, the server system receives a connection request from a client system (process block 130). At process block 135, the server system checks the connecting client system's binaries version. At decision block 140, it is determined whether the client's binaries are out-of-date. If it is determined that the client's binaries are out-of-date, then the server system automatically updates the client's binaries to the current version (process block 145). However, at process block 150, if it is determined that the client's binaries are up-to-date, then the connection request continues without performing an update.

In one embodiment, the client system initially connects to the server using a “thin login client.” The “thin login client” may be configured to allow the client to connect to the server regardless of the client's binary version. Thus, even if the client's binary version is significantly older than the server's binary version, the client would still be able to initially connect to the server in order to begin the updating process. In one embodiment, as part of the updating process, the “thin login client” may also be updated.

After logging on to the client system, in order for the server to update the client's binaries, the server may need elevated permissions (e.g., administrator permissions) to the client system. Hence, an elevated permission service (or process) may be launched prior to the updating process. In one embodiment, the elevated permission service launches an update process with elevated permissions. At this point, with the update process having elevated permissions running on the client system, the server system may proceed with updating the client system.

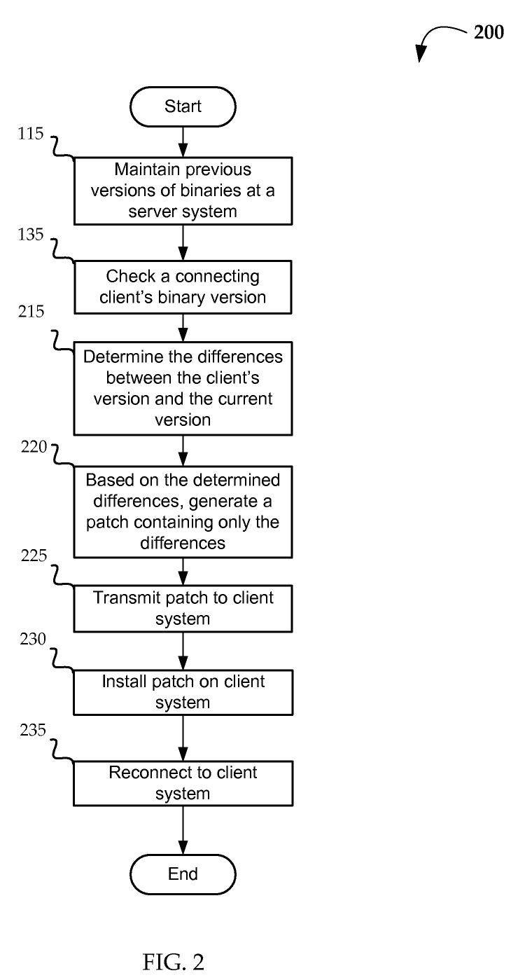

Referring now to FIG. 2, which illustrates one embodiment of a method 200 for generating a patch for a client system, according to aspects of the present invention. Initially, the server system will determine what differences there are between the client's binaries version and the server's binaries version (process block 215). In one embodiment, this determination may be made using delta coding. Thus, only the changed (or updated) portions of the binaries will be updated to the client system. This minimizes what is transmitted to the client system, making the update the smallest possible amount of data contained in the binaries.

At process block 220, based on the determined differences between the client system and the server system, a patch may be generated. In one embodiment, the patch may be stored by the server system to be used by subsequent client systems which connect to the server system and have the same update requirements. In an alternative embodiment, prior to generating a new patch, the previously generated patches can be searched to determine if the patch needed by the client has previously been generated. Accordingly, if it has been previously generated, then the server system can simply use the previously generated patch to update the client system, further conserving system resources. Furthermore, because multiple clients can use the same patch, many clients can be upgraded simultaneously without “timing-out” the server system. In one embodiment, the patch may be created using delta coding.

At process block 225, after the patch has been created or the appropriate patch has been located, the server system can transmit the patch to the client system. The patch may then be decoded and installed on the client system (process block 230). Following the installation of the patch on the client system, the server system may reconnect to the client system (process block 235). Upon reconnection, the server system determines that the client's binaries are now up-to-date, and so no updating process is needed.

In some situations it may be necessary to downgrade the server system. This may be due to a bug or glitch in an updated version, an incompatibility in the updated version, etc. Thus, because the server system maintains all previous versions of the binaries, the server system may simply install one of the previous versions stored at the server. Subsequently, when an updated client system connects to the server system, the server will determine that the client's binaries version differs from the server's binaries version, and the server will proceed with “updating” (essentially downgrading) the client's binaries to match the server's binaries. Hence, each time a client connects to the server, using the same process of updating the client's binaries, the server will downgrade the client's binaries to the previous version now installed on the server. Accordingly, each client is automatically synchronized with the server whether that be upgrading or downgrading the binaries version.

In a further embodiment, the binaries may contain various file types (e.g., dynamic link libraries (DLLs), text files, graphics files, executables (EXEs), etc.). In some instances the version number for the file may be the only change to the file. For example, the graphic file may be for the same graphic in which nothing has changed about the content of the file; however, the file may have only been assigned a new version number. In such a situation when the patch is being generated, instead of including the entire graphic file (which may be rather large), the patch can simply include a version number update for the file (which is significantly smaller than the entire file). Accordingly, not only does the patch merely include the updated portions of the binaries, the patch only includes the portions (i.e, the version number) of the updated portions needed to fully update the client systems.

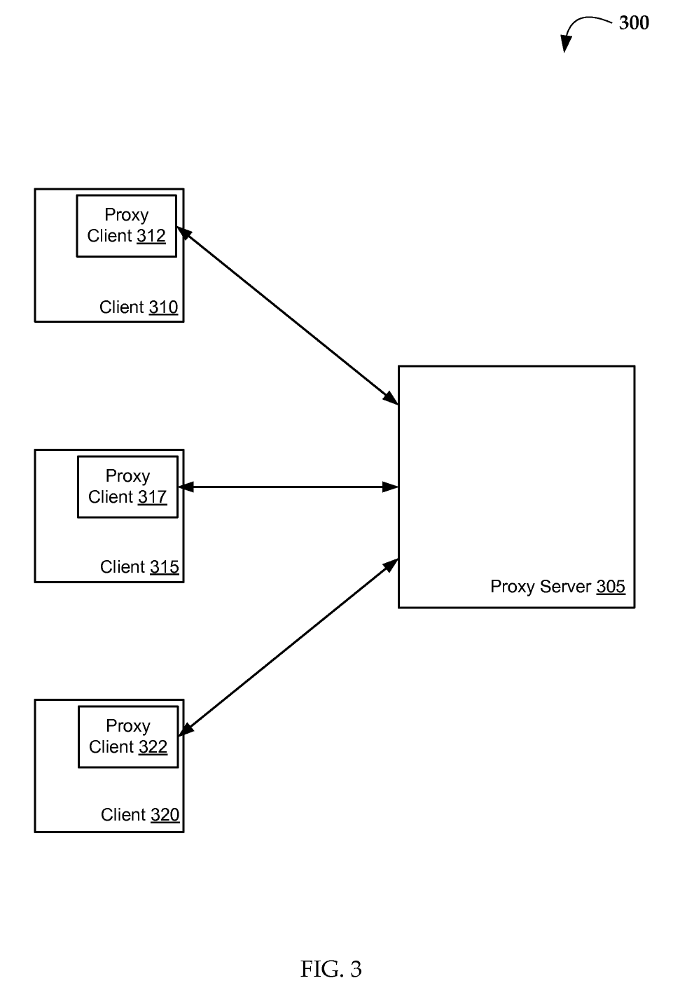

Referring now to FIG. 3 which illustrates one embodiment of a system 300 for automatically updating client systems and generating patches, according to aspects of the present invention. In one embodiment, system 300 may include a proxy server 305 and clients 310, 315, and 320. Clients 310-320 may be connected with proxy server 305 over a network connection medium. In a further embodiment, clients 310-320 may each include proxy clients 312, 317, and 322, respectively.

In one embodiment, clients 310-320 connect to proxy server 305 via proxy clients 312-322. Proxy clients 312-322 may include binaries used to propagate such a connection. In one embodiment, upon connection to proxy server 305, it may be determined that the binaries on proxy clients 312-322 are out-of-date (or out of sync) with proxy server 305's binaries. As such, according to methods 100 and 200 described above in FIGS. 1 and 2, the binaries on proxy clients 312-322 may be updated by proxy server 305. Thus, each time clients 310-320 connect with proxy server 305 their binaries will be updated to match the binaries on proxy server 305.

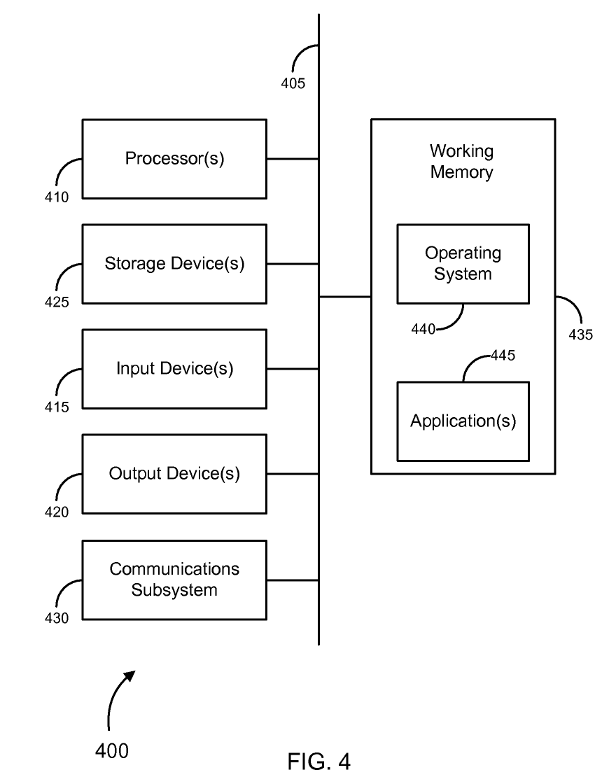

FIG. 4 provides a schematic illustration of one embodiment of a computer system 400 that can perform the methods of the invention, as described herein, and/or can function, for example, as any part of proxy server 305 or clients 310, 315, or 320 of FIG. 3. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements can include one or more processors 410, including without limitation one or more general-purpose processors and/or one or more special-purpose processors (such as digital signal processing chips, graphics acceleration chips, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440 and/or other code, such as one or more application programs 445, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 400) to perform methods of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another machine-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various machine-readable media might be involved in providing instructions/code to processor(s) 410 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 425. Volatile media includes, without limitation, dynamic memory, such as the working memory 435. Transmission media includes coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc., carried by the signals) to the working memory 435, from which the processor(s) 405 retrieves and executes the instructions. The instructions received by the working memory 435 may optionally be stored on a storage device 425 either before or after execution by the processor(s) 410.

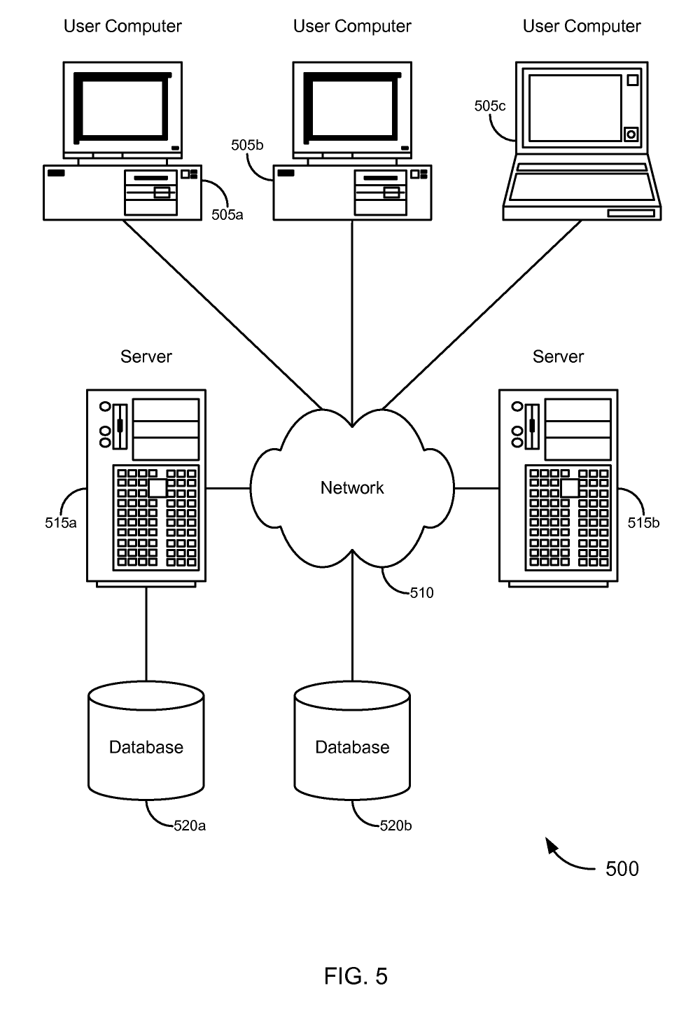

A set of embodiments comprises systems for automated patch creation. In one embodiment, proxy server 305 or clients 310, 315, or 320 of FIG. 3, may be implemented as computer system 400 in FIG. 4. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 505 can also have any of a variety of applications, including one or more applications configured to perform methods of the invention, as well as one or more office applications, database client and/or server applications, and web browser applications. Alternatively, the user computers 505 can be any other electronic device, such as a thin-client computer, Internet-enabled mobile telephone, and/or personal digital assistant (PDA), capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially available protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 505 to perform methods of the invention.

The server computers 515, in some embodiments, might include one or more application servers, which can include one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 505 and/or another server 515. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement methods of the invention incorporated by an application running on a user computer 505 and/or another server 515. Alternatively, as those skilled in the art will appreciate, a file server can include all necessary files, allowing such an application to be invoked remotely by a user computer 505 and/or server 515. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as the database can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of implementing software version management for automatically updating a client system, the method comprising:
establishing a server system and one or more client systems within a network;
installing binaries on the server system and the one or more client systems;
maintaining the installed binaries on the server system;
updating the server system with new binaries;
storing, on the server system, the previous binaries;
receiving a connection request to connect to the server system from at least one of the one or more client systems;
determining that the client system's binaries are out-of-date; and
automatically transmitting the new binaries to the client system to replace the out-of-date binaries.

2. The method of claim 1, further comprising:
determining a version of the client's binaries; and
based on the determined version, determining differences between the determined version and a current version of the server.

3. The method of claim 2, further comprising:
based on the determined differences, generating a patch configured to update the client system to the current version of the server system.

4. The method of claim 3, wherein the patch contains only updated files and new files contained in the current version which are not contained in the determined version.

5. The method of claim 3, wherein the generating of the patch is performed using delta coding.

6. The method of claim 5, wherein the patch includes at least one of dynamic link libraries (DLLs), executable files, text files, and graphics files.

7. The method of claim 6, wherein based on the delta coding, only including files in the patch that have changed from a previous version.

8. The method of claim 2, wherein a patch is generated for each instance of determined differences between a client version and the server version.

9. The method of claim 1, further comprising downgrading the server by installing a previous binary version maintained at the server.

10. The method of claim 9, further comprising downgrading a client by installing a previous binary version maintained at the server.

11. The method of claim 1, further comprising installing an enhanced permissions service on the one or more client systems.

12. The method of claim 11, wherein, the enhanced permissions service is configured to grant access needed to install the new binaries on the client system.

13. The method of claim 12, wherein after access is granted, the enhanced permissions service launches an update service configured to execute a binary update process.

14. The method of claim 1, further comprising installing a version independent thin login client configured to allow the server to access the one or more clients regardless of the versions of the one or more clients.

15. The method of claim 1, wherein the installing of the binaries on the server system and the one or more client systems initially uses Microsoft Windows installer (MSI).

16. A system for implementing software version management, the system comprising:
one or more client devices each having a proxy client; and
a proxy server in communication with the one or more client devices via the proxy clients, the proxy server having a storage device, and is configured to:
install binaries on the storage device,
direct the proxy clients to install the binaries on the one or more client devices,
maintain the installed binaries,
update the installed binaries on the storage device with new binaries,
store, on the storage device, the previous binaries,
receive a connection request from at least one of the one or more client devices via the proxy clients,
determine that the client system's binaries are out-of-date, and
automatically transmit the new binaries to the client system to replace the out-of-date binaries.

17. The system of claim 16, further comprising a content server in communication with the proxy server.

18. The system of claim 17, wherein the content server comprises one or more of the following: a web server, an email server, and a file server.

19. The system of claim 16, wherein the proxy server is further configured to determine a version of the client's binaries, and based on the determined version, determine differences between the determined version and a current version of the proxy server.

20. The system of claim 19, wherein, based on the determined differences, the proxy server is further configured to generate a patch configured to update the client system to the current version of the server system, wherein the patch contains only updated files and new files contained in the current version which are not contained in the determined version.

21. A machine-readable medium for automatic patch creation, including sets of instruction stored thereon which, when executed by a machine, cause the machine to:
establish a server system and one or more client systems within a network;
install binaries on the server system and the one or more client systems;
maintain the installed binaries on the server system;
update the server system with new binaries;
store, on the server system, the previous binaries;
receive a connection request to connect to the server system from at least one of the one or more client systems;
determine that the client system's binaries are out-of-date; and
automatically transmit the new binaries to the client system to replace the out-of-date binaries.
